(19) United States
(12) Patent Application Publication
(10) Pub. No.: US 2015/0278705 A1
(43) Pub. Date: Oct. 1, 2015

(54) CONTROL METHOD TO BE EXECUTED BY INFORMATION PROCESSING DEVICE, INFORMATION PROCESSING DEVICE, AND STORAGE MEDIUM

(71) Applicant: FUJITSU LIMITED, Kawasaki-shi (JP)

(72) Inventor: Yoshiro HADA, Atsugi (JP)

(73) Assignee: FUJITSU LIMITED, Kawasaki-shi (JP)

(21) Appl. No.: 14/730,976

(22) Filed: Jun. 4, 2015

Related U.S. Application Data
(63) Continuation of application No. PCT/JP2012/008084, filed on Dec. 18, 2012.

(51) Int. Cl. G06N 7/00; H04W 4/02; G05B 15/02

(52) U.S. Cl. CPC G06N 7/00; G05B 15/02; H04W 4/025

(57) ABSTRACT

A control method executed by an information processing device including a memory configured to store information of a plurality of behavioral patterns associated with positional information, the control method includes receiving, from a mobile device, a plurality of detected values associated with times and each including information of acceleration and an angular velocity; generating a behavioral pattern corresponding to the mobile device based on the plurality of detected values; determines a behavioral pattern that is among the plurality of behavioral patterns stored in the memory and is similar to the generated behavioral pattern; and acquiring positional information associated with the determined behavioral pattern.

### CROSS-REFERENCE TO RELATED APPLICATION

This application is a continuation application of International Application PCT/JP2012/008084 filed on Dec. 18, 2012 and designated the U.S., the entire contents of which are incorporated herein by reference.

### FIELD

The embodiment discussed herein is related to a control method to be executed by an information processing device, an information processing device, and a storage medium.

### BACKGROUND

For example, a mobile information terminal such as a smartphone uses a global positioning system (GPS), a wireless local area network (WLAN), a baseband, and the like to acquire information of the position of the mobile information terminal.

Regarding the GPS, however, since radio waves from satellites are weak, it is difficult to use the GPS to execute positioning in a building or the like. Regarding the WLAN, it is difficult to appropriately identify a floor (height) since a radio wave from an access point may reach another floor of a building through the WLAN. The baseband may be affected by the density of base stations and a building (an antenna or the like), and it is, therefore, difficult to accurately execute positioning.

Thus, a positioning technique that achieves accurate positioning without depending on the GPS, the WLAN, and the baseband has been disclosed. For example, a technique for identifying a building element based on a movement of a subject and acquiring, from a database, information of a position at which the building element is located has been disclosed. As related art, Japanese Laid-open Patent Publication No. 2005-257644 and the like have been disclosed, for example.

According to the conventional positioning technique, however, if multiple common building elements exist in a building, past history records are referenced, positional information is narrowed down, and it is, therefore, difficult to accurately acquire positional information.

### SUMMARY

According to an aspect of the invention, a control method executed by an information processing device including a memory configured to store information of a plurality of behavioral patterns associated with positional information, the control method includes receiving, from a mobile device, a plurality of detected values associated with times and each including information of acceleration and an angular velocity; generating a behavioral pattern corresponding to the mobile device based on the plurality of detected values; determines a behavioral pattern that is among the plurality of behavioral patterns stored in the memory and is similar to the generated behavioral pattern; and acquiring positional information associated with the determined behavioral pattern.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a positioning system according to an embodiment;

FIG. 2 is a schematic diagram illustrating a hardware configuration of a mobile information terminal according to the embodiment;

FIG. 3 is a schematic diagram illustrating functional blocks of the mobile information terminal according to the embodiment;

FIG. 4 is a flowchart of the acquisition of operational information by the mobile information terminal according to the embodiment;

FIG. 5 is a schematic diagram illustrating a hardware configuration of a first server according to the embodiment;

FIG. 6 is a schematic diagram illustrating functional blocks of the first server according to the embodiment;

FIGS. 7A and 7B are schematic diagrams illustrating first and second tables according to the embodiment;

FIG. 8 is a schematic diagram illustrating a specific example of a behavioral pattern of a user according to the embodiment;

FIG. 9 is a digraph of the behavioral pattern of the user according to the embodiment;

FIG. 10 is a flowchart of the acquisition of positional information by a process of matching behavioral patterns by the first server according to the embodiment;

FIG. 11 is a schematic diagram illustrating a hardware configuration of a second server according to the embodiment; and

FIG. 12 is a schematic diagram illustrating functional blocks of the second server according to the embodiment.

### DESCRIPTION OF EMBODIMENT

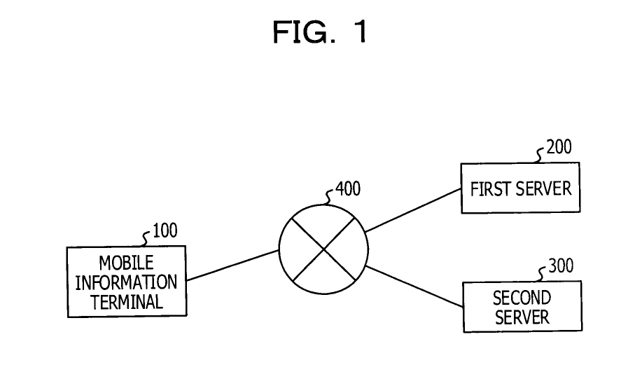

FIG. 1 is a schematic diagram illustrating a positioning system according to an embodiment.

As illustrated in FIG. 1, the positioning system according to the embodiment includes a mobile information terminal 100, a first server 200, and a second server 300. The mobile information terminal 100, the first server 200, and the second server 300 are coupled to each other through a wired or wireless network 400.

In the embodiment, the mobile information terminal 100 identifies behaviors of a user of the mobile information terminal 100 based on values detected by an acceleration sensor 106, a gyro sensor 107, and the like, for example. The identified behaviors are, for example, a “movement”, “stop”, an “upward movement”, and the like, for example. Then, the mobile information terminal 100 transmits, to the first server 200, data of the behaviors and the times when the behaviors occur.

The first server 200 acquires a behavioral pattern of the user of the mobile information terminal 100 based on the behavioral data transmitted by the mobile information terminal 100 and the times transmitted by the mobile information terminal 100. Then, the first server 200 extracts a behavioral pattern similar to the behavioral pattern of the user from multiple behavioral patterns stored in a learning database 215. The first server 200 transmits, to the second server 300, positional information associated with the behavioral pattern extracted from the learning database 215 as positional information of the mobile information terminal 100.

The second server 300 references a map database 303 and acquires a location name or facility name associated with the positional information transmitted by the first server 200 as a location or facility at which the mobile information terminal 100 is located. The second server 300 may provide, to the mobile information terminal 100, another server, or the like, the name of the location or facility at which the mobile information terminal 100 is located, for example.

As described above, in the embodiment, positional information of the mobile information terminal 100 is estimated based on a user's behavioral pattern identified from a movement of the mobile information terminal 100 and a behavioral pattern stored as learning data.

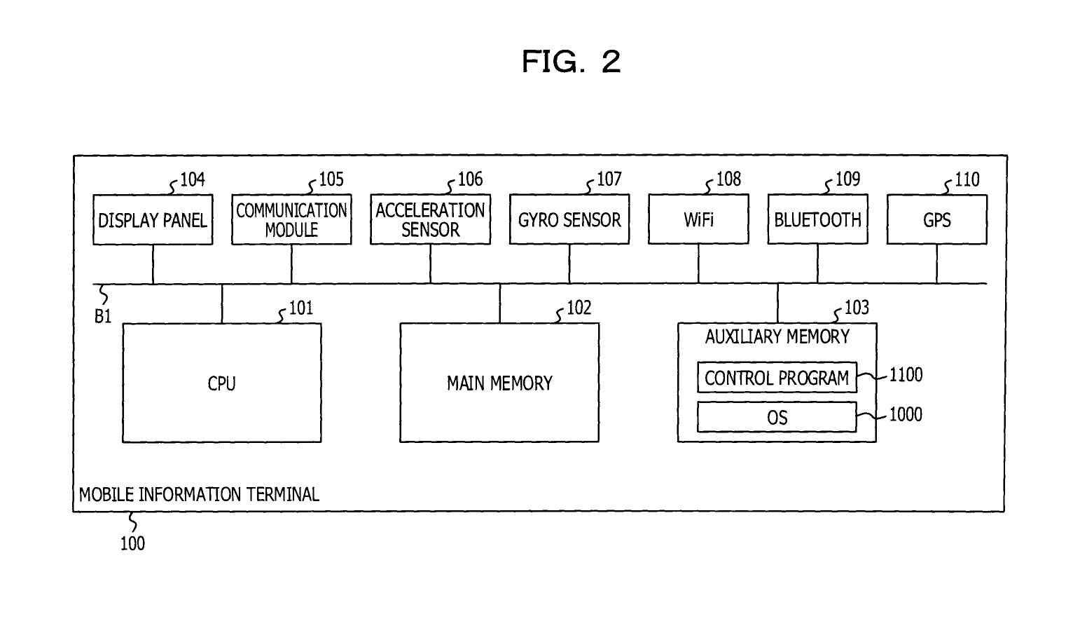

FIG. 2 is a schematic diagram illustrating a hardware configuration of the mobile information terminal 100 according to the embodiment.

As illustrated in FIG. 2, the mobile information terminal 100 according to the embodiment includes a central processing unit (CPU) 101, a main memory 102, an auxiliary memory 103, a display panel 104, a communication module 105, the acceleration sensor 106, the gyro sensor 107, a wireless fidelity (WiFi) scanning module 108 (hereinafter referred to as WiFi 108), a Bluetooth (registered trademark) scanning module 109 (hereinafter referred to as Bluetooth 109), and a global positioning system (GPS) module 110 (hereinafter referred to as GPS 110) as hardware modules. The hardware modules are coupled to each other by a bus B1.

The CPU 101 controls the hardware modules of the mobile information terminal 100. The CPU 101 reads various programs stored in the auxiliary memory 103 into the main memory 102, executes the various programs read in the main memory 102, and thereby achieves various functions. The various functions are described later in detail.

The main memory 102 stores the various programs to be executed by the CPU 101. The main memory 102 is used as a work area of the CPU 101 and stores various types of data to be used for processes to be executed by the CPU 101. The main memory 102 is, for example, a random access memory (RAM) or the like.

The auxiliary memory 103 stores various programs that cause the mobile information terminal 100 to operate. The various programs are an application program to be executed by the mobile information terminal 100, an OS 1000 that is an execution environment of the application program, and the like. A control program 1100 according to the embodiment is stored in the auxiliary memory 103. The auxiliary memory 103 is, for example, a hard disk or a nonvolatile memory such as a flash memory.

The display panel 104 presents image information to the user of the mobile information terminal 100. The display panel 104 includes a so-called touch screen and receives a position touched by a finger tip of the user or by an end of a pen.

The communication module 105 functions as an interface for communication using WiFi or a baseband, for example.

The acceleration sensor 106, the gyro sensor 107, the WiFi 108, and the Bluetooth 109 are sensors configured to acquire state information of the mobile information terminal 100. As the sensors, an illuminance sensor, a camera, a microphone, a barometer, and the like may be used.

The acceleration sensor 106 detects acceleration in three axial directions perpendicular to each other, for example. The gyro sensor 107 detects angular velocities around three axes perpendicular to each other, for example. The WiFi 108 scans a radio wave from an access point located near the mobile information terminal 100 and acquires a Media Access Control (MAC) address, a service set identifier (SSID), a received signal strength indication (RSSI), and the like of the access point. The Bluetooth 109 scans a device located near the mobile information terminal 100 and acquires information on the device.

The GPS 110 receives a GPS radio wave transmitted by an artificial satellite and calculates positional information of the mobile information terminal 100 or a longitude and latitude of the position of the mobile information terminal 100.

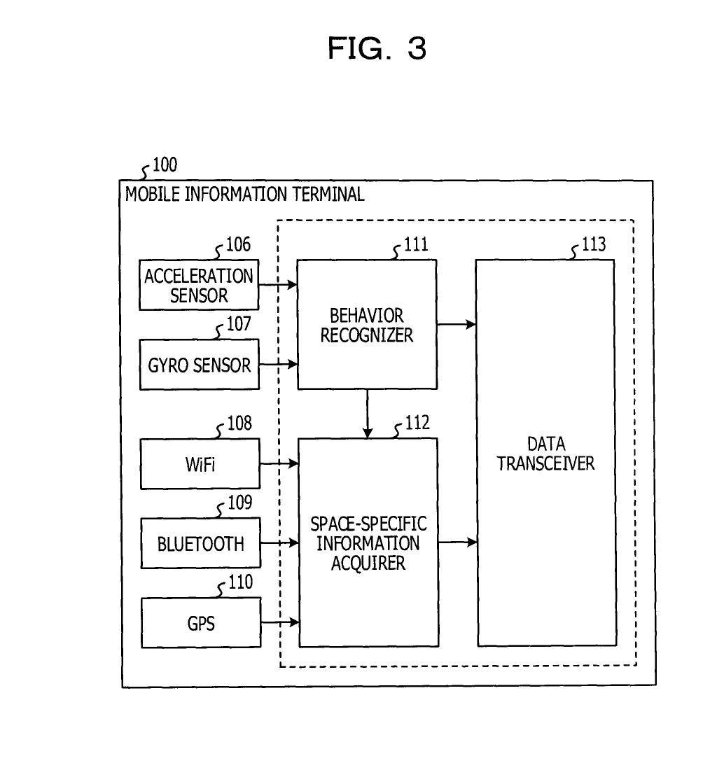

FIG. 3 is a schematic diagram illustrating functional blocks of the mobile information terminal 100 according to the embodiment.

As illustrated in FIG. 3, the mobile information terminal 100 according to the embodiment includes a behavior recognizer 111, a space-specific information acquirer 112, and a data transceiver 113.

The behavior recognizer 111, the space-specific information acquirer 112, and the data transceiver 113 are each achieved by causing the CPU 101 to read the control program 1100 into the main memory 102 and execute the control program 1100 read in the main memory 102.

The behavior recognizer 111 periodically acquires detected values of acceleration and angular velocities from the acceleration sensor 106 and the gyro sensor 107 and periodically acquires, from the acceleration sensor 106 and the gyro sensor 107, the times when the values are detected, for example. The behavior recognizer 111 identifies, based on at least either the detected values of the acceleration or the detected values of the angular velocities, the types of behaviors of the user of the mobile information terminal 100, such as a “movement”, “stop”, an “upward movement”, a “downward movement”, “sitting down”, “standing up”, and the like, for example.

When identifying a behavior of the user, the behavior recognizer 111 acquires a characteristic value of the transition between continuous two behaviors of the user. For example, if the behavior transitions from a “movement” to “stop”, the behavior recognizer 111 acquires, as the characteristic value, the number of steps from the start of the movement to the end of the movement. If the behavior transitions from “stop” to a “movement”, the behavior recognizer 111 acquires, as the characteristic value, a time period from the start of the stop to the end of the stop. If the behavior transitions from “stop” to an “upward movement”, the behavior recognizer 111 acquires, as the characteristic value, a time period from the start of the stop to the end of the stop. If the behavior transitions from an “upward movement” to “stop”, the behavior recognizer 111 acquires, as the characteristic value, a distance between the position of the mobile information terminal 100 at the start of the upward movement and the position of the mobile information terminal 100 at the end of the upward movement.

When identifying a behavior of the user, the behavior recognizer 111 notifies the space-specific information acquirer 112 of the time when the behavior occurs. The time when the behavior occurs may be the time when the behavior starts, the time when the behavior ends, or any time within a time period from the start of the behavior to the end of the behavior.

When the behavior recognizer 111 identifies a behavior of the user, the space-specific information acquirer 112 associates space-specific information with the time of the occurrence of the behavior and acquires the space-specific information. In the embodiment, the space-specific information acquirer 112 acquires, as the space-specific information, a MAC address, SSID, and RSSI of an access point on a wireless LAN and the time when the MAC address, the SSID, and the RSSI are detected by the WiFi 108. The space-specific information acquirer 112 acquires positional information (longitude and latitude) of the mobile information terminal 110 from the GPS 110.

The data transceiver 113 transmits, to the first server 200, data (hereinafter referred to as behavioral data) of behaviors identified by the behavior recognizer 111 and the times when the behaviors occur. The data transceiver 113 transmits, to the first server 200, MAC addresses acquired by the space-specific information acquirer 112, SSIDs acquired by the space-specific information acquirer 112, the maximum and minimum values of RSSIs acquired by the space-specific information acquirer 112 and the times when the MAC addresses, the SSIDs, and the RSSIs are detected by the WiFi 108. The data transceiver 113 may receive location information transmitted by the second server 300. When the space-specific information acquirer 112 acquires positional information of the mobile information terminal 100, the data transceiver 113 transmits the positional information of the mobile information terminal 100 to the first server 200.

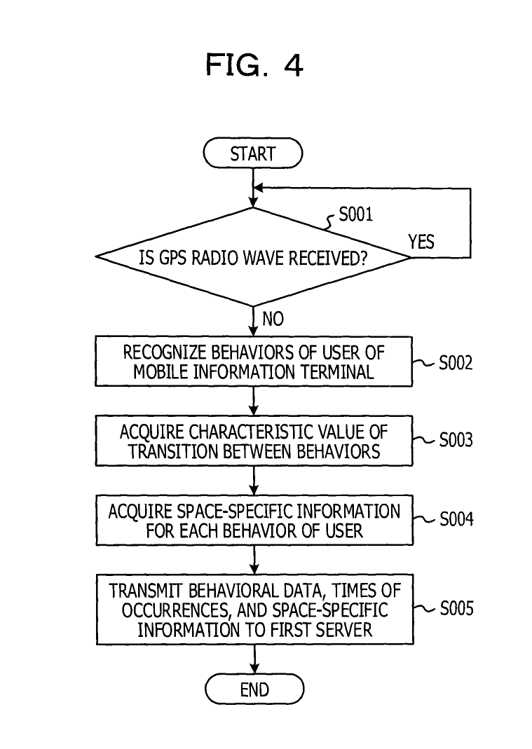

FIG. 4 is a flowchart of a behavior sensing process to be executed by the mobile information terminal 100 according to the embodiment.

As illustrated in FIG. 4, first, the space-specific information acquirer 112 determines, based on a value output from the GPS 110, whether a radio wave is received from a GPS satellite (in S001).

If the space-specific information acquirer 112 determines that the radio wave is received from the GPS satellite (Yes in S001), the space-specific information acquirer 112 continues to acquire positional information (longitude and latitude) of the mobile information terminal 100 based on the GPS radio wave. After a predetermined time elapses, the space-specific information acquirer 112 determines again whether a GPS radio wave is received (in S001).

On the other hand, if the space-specific information acquirer 112 determines that the radio wave is not received from the GPS satellite (No in S001), the behavior recognizer 111 recognizes behaviors of the user of the mobile information terminal 100 based on values detected by the acceleration sensor 106 and gyro sensor 107 (in S002). For example, the behavior recognizer 111 recognizes “walking”, “stop”, an “upward movement”, “sitting down”, “standing up”, and the like of the user.

In this case, if multiple behaviors are recognized, the behavior recognizer 111 acquires, based on the values detected by the acceleration sensor 106 and gyro sensor 107, any of the number of steps, a time period, and a distance as a characteristic value of the transition between the continuous two behaviors (in S003).

Next, when specific behaviors are recognized by the behavior recognizer 111, the space-specific information acquirer 112 associates a MAC address, an SSID, an RSSI, and the like as space-specific information with the behaviors and acquires the space-specific information, based on a beacon wave from a WiFi access point (in S004). The specific behaviors are behaviors acquired as learning data in advance. For example, if an “upward movement” is recognized by the behavior sensing process, but an “upward movement” is not recorded in the learning data, the space-specific information acquirer 112 may omit the acquisition of space-specific information.

Next, the data transceiver 113 transmits, to the first server 200, data representing the specific behaviors and acquired by the behavior recognizer 111, the times when the behaviors occur, and the space-specific information acquired by the space-specific information acquirer 112 (in S005).

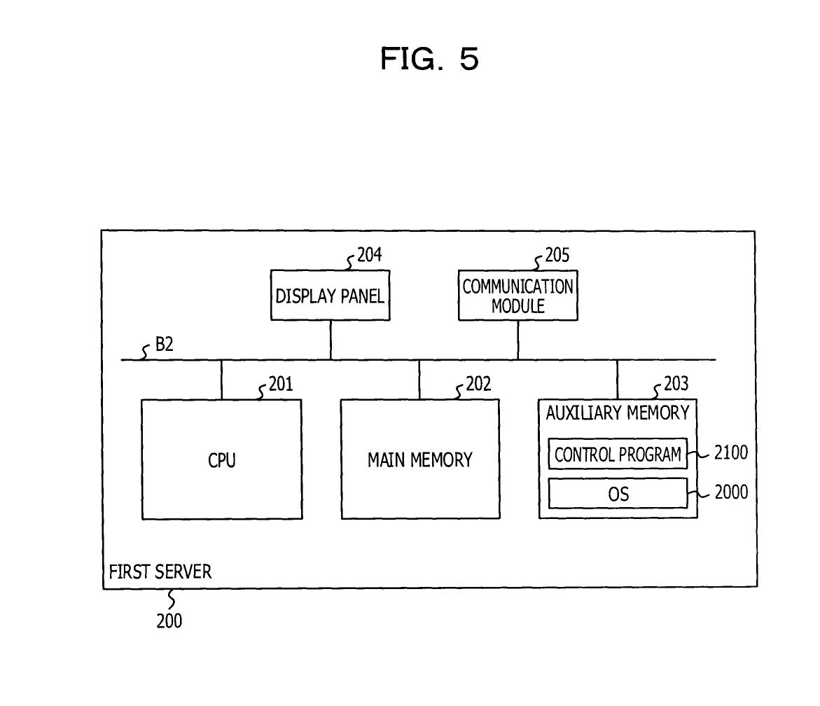

FIG. 5 is a schematic diagram illustrating a hardware configuration of the first server 200 according to the embodiment.

As illustrated in FIG. 5, the first server 200 according to the embodiment includes a CPU 201, a main memory 202, an auxiliary memory 203, a display panel 204, and a communication module 205 as hardware modules. The hardware modules are coupled to each other by a bus B2.

The CPU 201 controls the hardware modules of the first server 200. The CPU 201 reads various programs stored in the auxiliary memory 203 into the main memory 202, executes the various programs read in the main memory 202, and thereby achieves various functions. The various functions are described later in detail.

The main memory 202 stores the various programs to be executed by the CPU 201. The main memory 202 is a work area of the CPU 201 and stores various types of data to be used for processes to be executed by the CPU 201. The main memory 202 is, for example, a RAM or the like.

The auxiliary memory 203 stores various programs that cause the first server 200 to operate. The various programs are, for example, an application program to be executed by the first server 200, an OS 2000 that is an execution environment of the application program, and the like. A control program 2100 according to the embodiment is stored in the auxiliary memory 203. The auxiliary memory 203 is, for example, a hard disk or a nonvolatile memory such as a flash memory.

The display panel 204 presents image information to a user of the first server 200. The communication module 205 functions as an interface for communication with the mobile information terminal 100 or the second server 300.

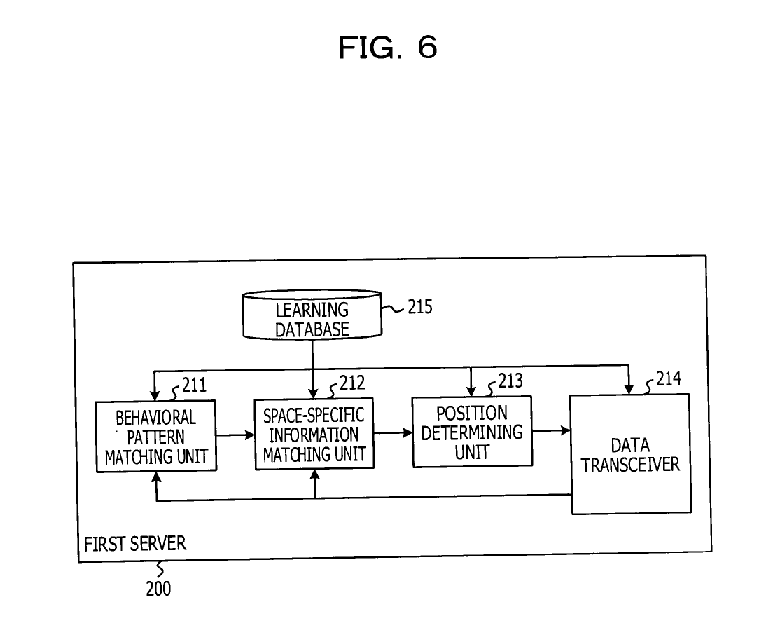

FIG. 6 is a schematic diagram illustrating functional blocks of the first server 200 according to the embodiment.

As illustrated in FIG. 6, the first server 200 according to the embodiment includes a behavioral pattern matching unit 211, a space-specific information matching unit 212, a position determining unit 213, a data transceiver 214, and a learning database 215.

The behavioral pattern matching unit 211, the space-specific information matching unit 212, the position determining unit 213, the data transceiver 214, and the learning database 215 are each achieved by causing the CPU 201 to read the control program 2100 into the main memory 202 and execute the control program 2100 read in the main memory 202.

The behavioral pattern matching unit 211 generates a behavioral pattern vector and a behavioral characteristic vector as a behavioral pattern of the user based on behavioral data transmitted by the mobile information terminal 100 and time data transmitted by the mobile information terminal 100.

The behavioral pattern vector is a vector having elements that represent behaviors of the user. In the embodiment, the behavioral pattern vector is formed by assigning numerical values to the behaviors. For example, if the user behaves in order of a “movement”, “stop”, an “upward movement”, and “stop”, the behavioral pattern matching unit 211 assigns numeral values “1”, “2”, and “3” to the behaviors “movement”, “stop”, and “upward movement”, respectively. Then, the behavioral pattern matching unit 211 generates Vp=(1, 2, 3, 2)^{T} as a behavioral pattern vector Vp, where T is a sign representing transposition.

The behavioral characteristic vector is a vector having elements that represent characteristic values of the transitions between pairs of continuous behaviors. For example, if the number of steps from the “movement” to the “stop” is 40, a time period from the “stop” to the “upward movement” is 10 seconds, and a distance between the position of the mobile information terminal 100 at the time of the “upward movement” and the position of the mobile information terminal 100 at the time of “stop” is 8 meters, the behavioral pattern matching unit 211 assigns “40”, “10”, and “8” to characteristic values of the transitions. Then, the behavioral pattern matching unit 211 generates Vf=(40, 10, 8)^{T} as a behavioral characteristic vector.

Although the behavioral pattern vector and the behavioral characteristic vector are generated as the behavioral pattern in the embodiment, the embodiment is not limited to this. As long as how the user of the mobile information terminal 100 behaves and reaches a certain position is represented, another index may be used.

The behavioral pattern matching unit 211 extracts, from behavioral pattern vectors recorded in a first table T1 of the learning database 215, a behavioral pattern vector that is similar to the behavioral pattern vector generated from the behavioral data of the user. The extraction of the behavioral pattern vector is described later in detail.

The space-specific information matching unit 212 compares space-specific information acquired by the mobile information terminal 100 with space-specific information associated with behaviors that are constituent elements of the behavioral pattern vector extracted by the behavioral pattern matching unit 211.

For example, if a MAC address, SSID, and RSSI of a WiFi access point are used as space-specific information, the space-specific information matching unit 212 determines, for each behavior of a behavioral pattern, whether the MAC address acquired by the mobile information terminal 100 matches a MAC address recorded in a second table T2 of the learning database 215. In addition, the space-specific information matching unit 212 determines whether the RSSI acquired by the mobile information terminal 100 is in a range between the maximum value and minimum value of RSSIs recorded in the second table T2 of the learning database 215.

The position determining unit 213 calculates, based on the results of the comparison made by the space-specific information matching unit 212, a score value that is an index for matching of space-specific information. The calculation of the score value is described later in detail.

The position determining unit 213 determines whether the score value is larger than a predetermined threshold. If the position determining unit 213 determines that the score value is larger than the threshold, the position determining unit 213 references the first table T1 of the learning database 215 and treats positional information associated with the behavioral pattern vector extracted by the behavioral pattern matching unit 211 as positional information of the mobile information terminal 100. The positional information includes a longitude, a lattice, and a height.

The data transceiver 214 transmits the positional information acquired by the position determining unit 213 to the second server 300. The data transceiver 214 receives behavioral data, time data, and positional information from the mobile information terminal 100.

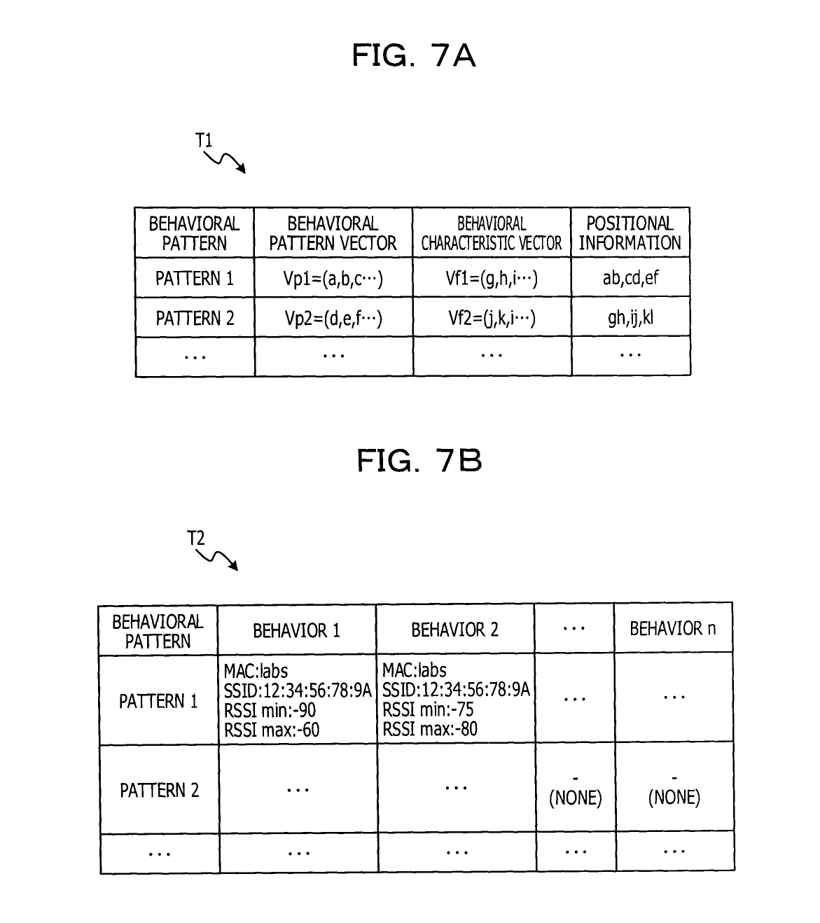

FIGS. 7A and 7B are schematic diagrams illustrating the first and second tables T1 and T2 according to the embodiment.

The first and second tables T1 and T2 are stored in the auxiliary memory 203. The first and second tables T1 and T2 are acquired as learning data in advance.

As illustrated in FIG. 7A, the first table T1 stores a behavioral pattern vector, a behavioral characteristic vector, and positional information for each of behavioral patterns. The positional information is a current position or target position (destination) estimated from each of the behavioral patterns of the user. The behavioral pattern vectors and the behavioral characteristic vectors are described later.

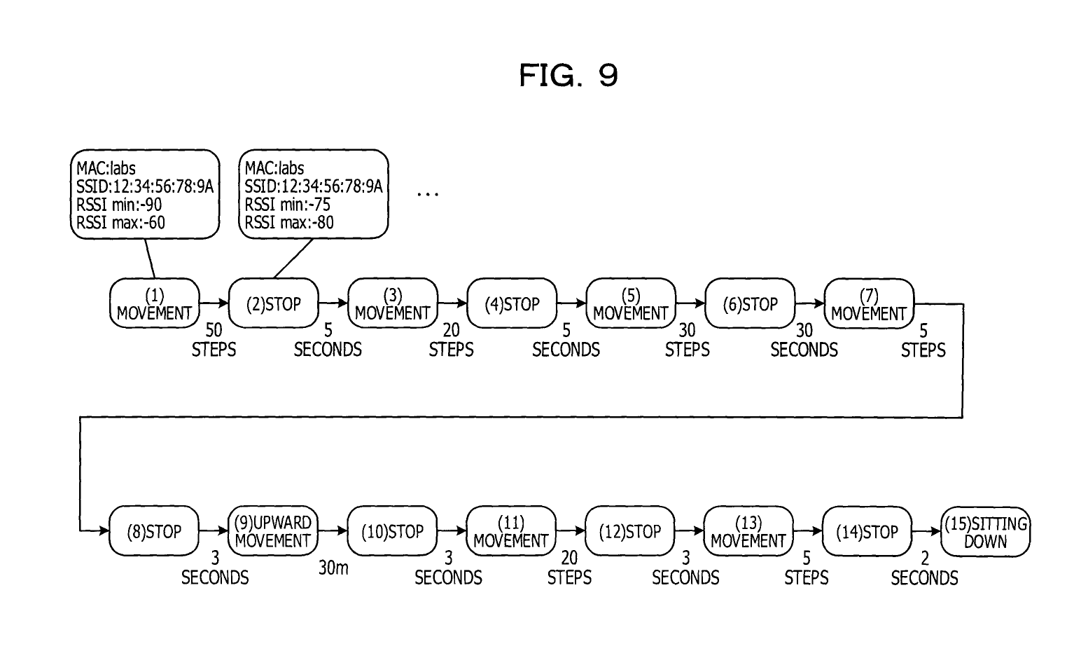

As illustrated in FIG. 7B, the second table T2 stores space-specific information corresponding to nodes of a behavioral pattern digraph illustrated in FIG. 9. In an example illustrated in FIG. 7B, WiFi MAC addresses, WiFi SSIDs, and the maximum values and minimum values of WiFi RSSIs are monitored upon learning of the behavioral patterns and recorded in the second table T2. The behavioral pattern digraph is described later.

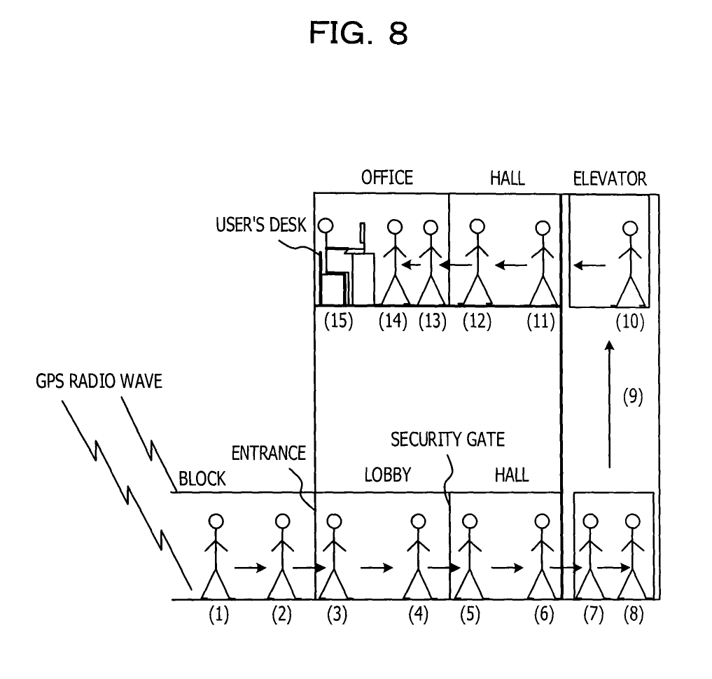

FIG. 8 is a schematic diagram illustrating a specific example of a user's behavioral pattern according to the embodiment. FIG. 9 is the digraph of the behavioral pattern according to the embodiment. The digraph illustrated in FIG. 9 is referred to as the behavioral pattern digraph.

FIGS. 8 and 9 assume user's behaviors up to sitting down at a user's desk of a company. As illustrated in FIGS. 8 and 9, the user of the mobile information terminal 100, (1) moves to an entrance of a building (50 steps), (2) stops in front of the entrance (for 5 seconds), (3) moves to a security gate after opening of an entrance door (20 steps), (4) stops in front of the security gate (for 5 seconds), (5) moves to an elevator after passing through the security gate (30 steps), (6) stops in front of the elevator (for 30 seconds), (7) moves into a box of the elevator after opening of an elevator door (5 steps), (8) stops within the box of the elevator (for 3 seconds), (9) is moved up by the elevator (30 meters), (10) stops at a certain floor (for 3 seconds), (11) moves to an office after opening of the elevator door (20 steps), (12) stops in front of the office (for 3 seconds), (13) moves to the user's desk after opening of an office door (5 steps), (14) stops in front of the user's desk (for 2 seconds), and (15) sits down at the user's desk.

Thus, the first server 200 chronologically receives, from the mobile information terminal 100, behavioral data that is “(1) movement”, “(2) stop”, “(3) movement”, “(4) stop”, “(5) movement”, “(6) stop”, “(7) movement”, “(8) stop”, “(9) upward movement”, “(10) stop”, “(11) movement”, “(12) stop”, “(13) movement”, “(14) stop”, and “(15) sitting down”.

The first server 200 receives, from the mobile information terminal 100, 50 steps as a characteristic value of the transition from “(1) movement” to “(2) stop”, 5 seconds as a characteristic value of the transition from “(2) stop” to “(3) movement”, 20 steps as a characteristic value of the transition from “(3) movement” to “(4) stop”, 5 seconds as a characteristic value of the transition from “(4) stop” to “(5) movement”, 30 steps as a characteristic value of the transition from “(5) movement” to “(6) stop”, 30 seconds as a characteristic value of the transition from “(6) stop” to “(7) movement”, 5 steps as a characteristic value of the transition from “(7) movement” to “(8) stop”, 3 seconds as a characteristic value of the transition from “(8) stop” to “(9) upward movement”, 30 meters as a characteristic value of the transition from “(9) upward movement” to “(10) stop”, 3 seconds as a characteristic value of the transition from “(10) stop” to “(11) movement”, 20 steps as a characteristic value of the transition from “(11) movement” to “(12) stop”, 3 seconds as a characteristic value of the transition from “(12) stop” to “(13) movement”, 5 steps as a characteristic value of the transition from “(13) movement” to “(14) stop”, and 2 seconds as a characteristic value of the transition from “(14) stop” to “(15) sitting down”.

The behavioral pattern matching unit 211 assigns numerical values “1”, “2”, “3”, and “4” to “movement”, “stop”, “upward movement”, and “sitting down”, respectively. Then, the behavioral pattern matching unit 211 generates a behavioral pattern vector Vp using the numerical values as elements. The behavioral pattern vector Vp according to this example is expressed by the following Equation (F1).

Vp=(1, 2, 1, 2, 1, 2, 1, 2, 3, 2, 1, 2, 1, 2, 4)^{T} (F1)

The elements of the behavioral pattern vector Vp expressed by Equation (F1) correspond to the nodes of the behavioral pattern digraph illustrated in FIG. 9. The behavioral pattern matching unit 211 may assign a numerical value “0” to a movement (switching) from an outdoor place to an indoor place and generate a behavioral pattern vector Vp′. The behavioral pattern vector Vp′ according to this example is expressed by the following Equation (F1′).

Vp′=(1, 2, 0, 1, 2, 1, 2, 1, 2, 3, 2, 1, 2, 1, 2, 4)^{T} (F1′)

The behavioral pattern matching unit 211 assigns numeral values to characteristic values of the transitions between pairs of continuous behaviors. Then, the behavioral pattern matching unit 211 generates a behavioral characteristic vector Vf using the numerical values as elements. The behavioral characteristic vector Vf according to this example is expressed by the following Equation (F2).

Vf=(50, 5, 20, 5, 30, 30, 5, 3, 30, 3, 20, 3, 5, 2)^{T} (F2)

The elements of the behavioral characteristic vector Vf expressed by Equation (F2) correspond to weights associated with branches of the digraph illustrated in FIG. 9.

Upon the learning of the behavioral pattern, the behavioral pattern vector Vp, the behavioral characteristic vector Vf, and space-specific information corresponding to the elements of the behavioral pattern vector, are stored as learning data in the learning database 215 in the form of the tables T1 and T2 illustrated in FIGS. 7A and 7B.

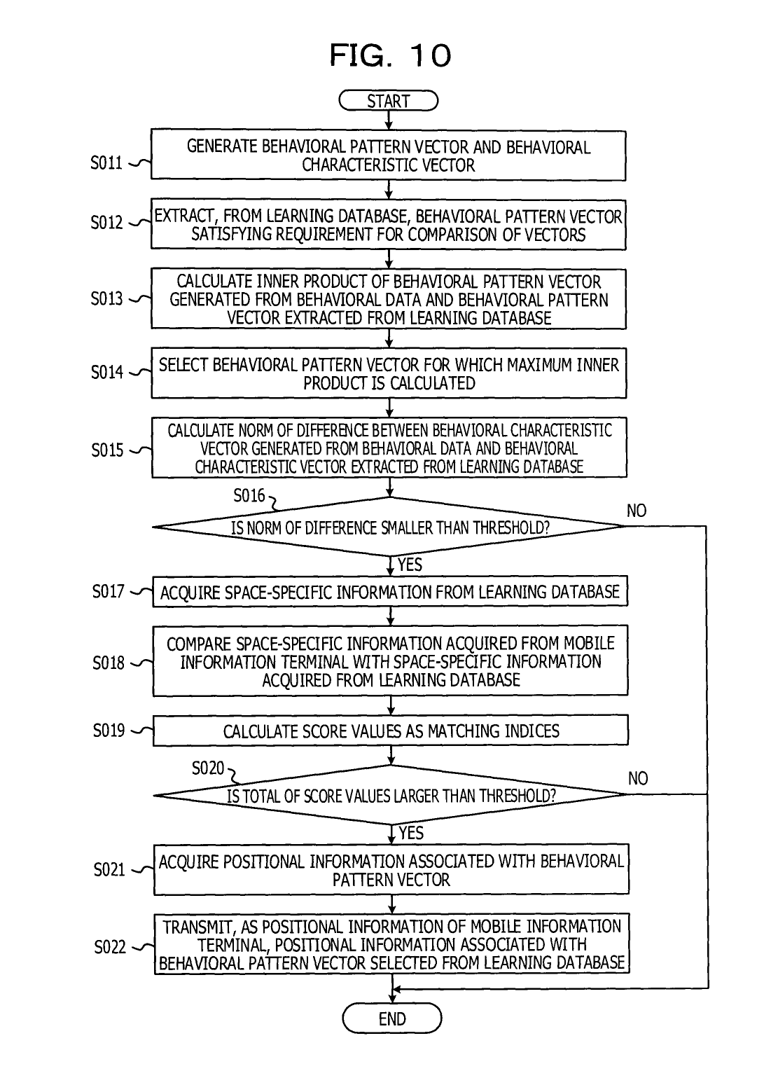

FIG. 10 is a flowchart of the acquisition of positional information by a process of matching behavioral patterns by the first server 200 according to the embodiment.

As illustrated in FIG. 10, first, the behavioral pattern matching unit 211 generates a behavioral pattern vector based on user's behavioral data received from the mobile information terminal 100. Then, the behavioral pattern matching unit 211 generates a behavioral characteristic vector corresponding to a time period up to the current time based on characteristic data received from the mobile information terminal 100 (in S011).

Next, the behavioral pattern matching unit 211 searches multiple behavioral pattern vectors stored in the first table T1 of the learning database 215 and extracts, from the searched behavioral pattern vectors, a behavioral pattern vector satisfying a requirement for comparison of vectors (in S012).

Specifically, the behavioral pattern matching unit 211 extracts, from the learning database 215, a behavioral pattern vector that is common, in terms of behaviors at the start and end points of a behavioral pattern and the number of behaviors of the behavioral pattern, to a behavioral pattern vector corresponding to a time period up to the current time and generated from data of a series of behaviors recognized based on information detected by the sensors of the mobile information terminal held by the user. In the aforementioned specific example, the behavior of the start point of the behavioral pattern is “movement”, the behavior of the end point of the behavioral pattern is “sitting down”, the number of the behaviors is 15, and thus the “fifteen dimensional” behavior pattern vector that includes the top vector element “1” and the last vector element “4” is extracted.

Next, the behavioral pattern matching unit 211 calculates an inner product of the behavioral pattern vector generated from the behavioral data of the user and the behavioral pattern vector extracted from the first table T1 of the learning database 215 (in S013). If multiple behavioral pattern vectors are extracted from the first table T1 of the learning database 215, the behavioral pattern matching unit 211 calculates an inner product for each of the behavioral pattern vectors extracted from the learning database 215.

Next, the behavioral pattern matching unit 211 selects a behavioral pattern vector for which the maximum inner product is calculated from among the behavioral pattern vectors extracted from the first table T1 of the learning database 215 (in S014).

Next, the behavioral pattern matching unit 211 calculates a norm of the difference between the behavioral characteristic vector generated from the characteristic data of the behaviors of the user and corresponding to the time period up to the current time and a behavioral characteristic vector associated with the behavioral pattern vector for which the maximum inner product is calculated in the previous process and that is extracted from the first table T1 of the learning database 215 (in S015).

Next, the behavioral pattern matching unit 211 determines whether the norm of the difference between the behavioral characteristic vector generated from the characteristic data of the user and the behavioral characteristic vector calculated from the learning database 215 is smaller than a predetermined threshold (in S016).

If the behavioral pattern matching unit 211 determines that the norm is not smaller than the threshold (No in S016), the behavioral pattern matching unit 211 determines that a behavioral pattern vector that is similar to the behavioral pattern vector generated from the behavioral data of the user or the behavioral pattern of the user is not registered in the learning database 215, and the behavioral pattern matching unit 211 terminates the matching process according to the embodiment.

On the other hand, if the behavioral pattern matching unit 211 determines that the norm is smaller than the threshold (Yes in S016), the space-specific information matching unit 212 acquires, from the second table T2 of the learning database 215, space-specific information associated with behaviors that are constituent elements of the behavioral pattern vector for which the maximum inner product is calculated (in S017).

Next, the space-specific information matching unit 212 compares, for each behavior of the behavioral pattern vector generated from the behavioral data of the user, space-specific information acquired from the mobile information terminal 100 with the space-specific information acquired from the learning database 215 (in S018).

Specifically, the space-specific information matching unit 212 determines, for each of the behaviors of the behavioral pattern, whether a WiFi MAC address included in the space-specific information acquired from the mobile information terminal 100 is common to a MAC address acquired from the learning database 215. Then, the space-specific information matching unit 212 determines whether a WiFi RSSI acquired from the mobile information terminal 100 is in a range between the minimum value and maximum value of RSSIs acquired from the learning database 215.

Next, the position determining unit 213 calculates score values as indices for matching based on the results of the comparison of the space-specific information acquired from the mobile information terminal 100 with the space-specific information acquired from the learning database 215 (in S019).

Specifically, the position determining unit 213 first initializes the score values to 0 (zero). Then, the position determining unit 213 compares the space-specific information associated with the behaviors of the behavioral pattern recognized using the mobile information terminal 100 and corresponding to the time period up to the current time with the space-specific information acquired from the learning database 215. More specifically, if a WiFi MAC address that is included in the associated space-specific information is common to a MAC address acquired from the learning database 215, and an RSSI acquired from the mobile information terminal 100 is in the range between the minimum value and maximum value of the RSSIs acquired from the learning database 215, the position determining unit 213 sets a score value as a matching index to “+1” in order from the start point of the behavioral pattern recognized using the mobile information terminal 100 and corresponding to the time period up to the current time. The score values are calculated for all the behaviors that are the constituent elements of the behavioral pattern, and the total of the calculated score values is calculated.

Next, the position determining unit 213 determines whether the total of the score values is larger than a predetermined threshold (in S020).

If the position determining unit 213 determines that the total of the score values is not larger than the threshold (No in S020), the position determining unit 213 determines that the behavioral pattern of the user is not registered in the learning database 215, and the position determining unit 213 terminates the matching process according to the embodiment.

On the other hand, if the position determining unit 213 determines that the total of the score values is larger than the threshold (Yes in S020), the position determining unit 213 determines that the behavioral pattern vector generated from the behavioral data is similar to the behavioral pattern vector selected from the learning database 215 or the behavioral pattern of the user is similar to a behavioral pattern selected from the learning database 215. Then, the position determining unit 213 acquires, as a current position or target position of the user, positional information associated with the behavioral pattern vector selected from the learning database 215 (in S021).

Next, the data transceiver 214 transmits, as positional information of the mobile information terminal 100, the positional information acquired by the position determining unit 213 to the second server 300 (in S022).

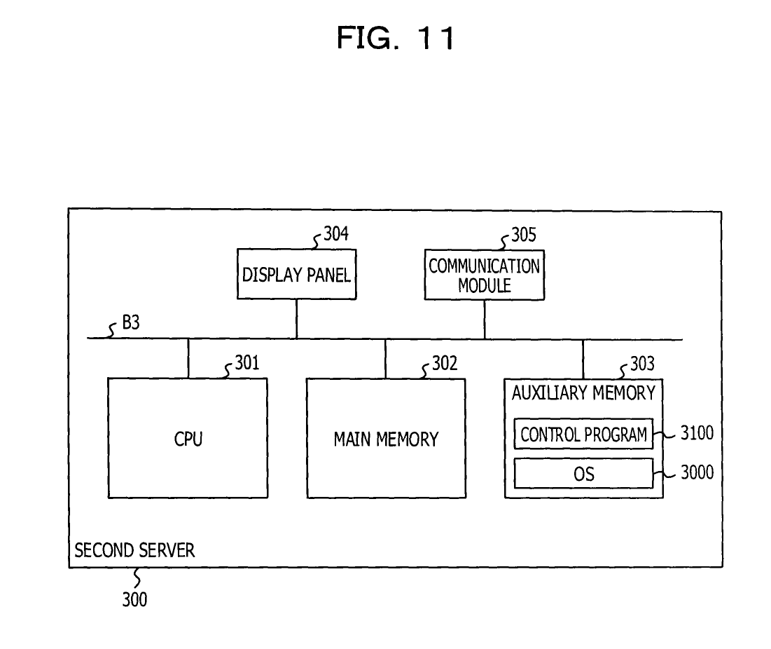

FIG. 11 is a schematic diagram illustrating a hardware configuration of the second server 300 according to the embodiment.

As illustrated in FIG. 11, the second server 300 according to the embodiment includes a CPU 301, a main memory 302, an auxiliary memory 303, a display panel 304, and a communication module 305 as hardware modules. The hardware modules are coupled to each other by a bus B3.

The CPU 301 controls the hardware modules of the second server 300. The CPU 301 reads various programs stored in the auxiliary memory 303 into the main memory 302, executes the various programs read in the main memory 302, and thereby achieves various functions. The various functions are described later in detail.

The main memory 302 stores the various programs to be executed by the CPU 301. The main memory 302 is used as a work area of the CPU 301 and stores various types of data to be used for processes to be executed by the CPU 301. The main memory 302 is, for example, a RAM or the like.

The auxiliary memory 303 stores various programs that cause the second server 300 to operate. The various programs are an application program to be executed by the second server 300, an OS 3000 that is an execution environment of the application program, and the like. A control program 3100 according to the embodiment is stored in the auxiliary memory 303. The auxiliary memory 303 is, for example, a hard disk or a nonvolatile memory such as a flash memory.

The display panel 304 presents image information to a user of the second server 300. The communication module 305 functions as an interface for communication with the mobile information terminal 100 or the first server 200.

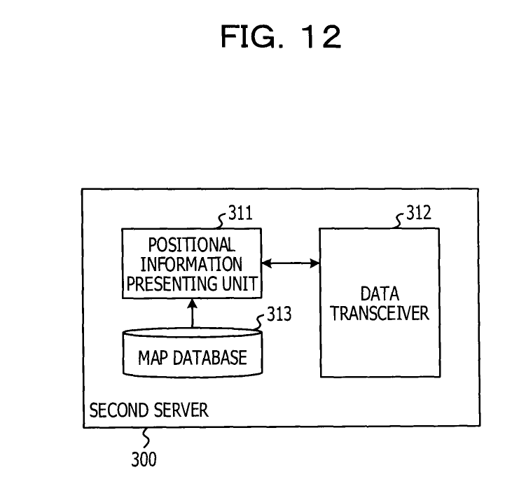

FIG. 12 is a schematic diagram illustrating functional blocks of the second server 300 according to the embodiment.

As illustrated in FIG. 12, the second server 300 according to the embodiment includes a positional information presenting unit 311, a data transceiver 312, and a map database 313.

The positional information presenting unit 311, the data transceiver 312, and the map database 313 are each achieved by causing the CPU 301 to read the control program 3100 into the main memory 302 and execute the control program 3100 read in the main memory 302.

The positional information presenting unit 311 references map data stored in the map database 313 and acquires a location name or facility name associated with positional information transmitted by the second server 300. The positional information presenting unit 311 may notify the mobile information terminal 100 or the other server of the location name or facility name acquired from the map database 313.

The data transceiver 312 receives positional information transmitted by the first server 200. The data transceiver 312 may transmit, to the mobile information terminal 100 or the other server, the location name or facility name acquired by the positional information presenting unit 311.

The map database 313 is built in the auxiliary memory 303. The map database 313 is a database in which positional information is associated with context information such as location names and facility names.

In order to generate the learning database 215, the user inputs a starting point and an arrival point from the display panel 104 of the mobile information terminal 100 set in a learning mode. Subsequently, the user actually moves from the starting point to the arrival point while holding the mobile information terminal 100. Since pairs of points in a building are infinite, multiple users may perform the aforementioned task.

When the mobile information terminal 100 is set to the learning mode, an input screen is displayed on the display panel 104 of the mobile information terminal 100. The input screen includes an input format related to positional information of the starting point and the arrival point.

Next, the mobile information terminal 100 receives details input to the input format and related to the positional information of the starting point and the arrival point and transmits the input details to a dedicated server. A map may be displayed on the input screen, and coordinates corresponding to a position specified by the user on the map may be treated as the input details or input information. In this case, a coordinate system may be WGS-84 coordinate system generally used for GPSs, or the coordinates may be coordinates viewed from a standard coordinate system fixed and provided for a building if the mobile information terminal 100 is located in the building. Alternatively, a location name such as a “user's desk”, a “meeting room A”, or an “elevator hall 1” may be used.

Next, the mobile information terminal 100 acquires, based on values detected by the acceleration sensor 106 and gyro sensor 107, behaviors of the user, the times when the behaviors occur, and characteristic values of the behaviors. Then, the mobile information terminal 100 acquires space-specific information such as MAC addresses, SSIDs, RSSIs, and the like from access points installed at positions in the building, for example.

Subsequently, when acquiring a behavior of the user, the mobile information terminal 100 transmits, to the dedicated server, data of the behavior, the time when the behavior occurs, a characteristic value of the transition from the previous behavior to the current behavior, and space-specific information acquired when the behavior occurs.

The dedicated server generates a behavioral pattern (a behavioral pattern vector and a behavioral characteristic vector) from a starting point to an arrival point based on user's behavioral data transmitted by the mobile information terminal 100, the times when behaviors occur, the starting point, and the arrival point and registers the generated behavioral pattern in the first table T1 of the learning database 215. When acquiring a new starting point and a new arrival point from the mobile information terminal 100, the dedicated server generates the first table T1 of the learning database 215 by repeating the aforementioned operation.

The dedicated server associates the space-specific information transmitted by the mobile information terminal 100 with behaviors and registers the space-specific information in the second table T2 of the learning database 215. When acquiring behavioral data from the mobile information terminal 100, the dedicated server generates the second table T2 of the learning database 215 by repeating the aforementioned operation.

According to the embodiment, positional information of the mobile information terminal 100 is acquired based on a behavioral pattern of the user of the mobile information terminal 100. Accurate positional information may be acquired without being affected by a facility for positioning. For example, in positioning using a wireless LAN, if an access point is installed near a ceiling, a beacon signal from the access point may reach a floor on which the access point is installed and a floor located above the floor on which the access point is installed. It is, therefore, difficult to acquire accurate positional information of the user of the mobile information terminal 100. In the embodiment, however, positional information of the mobile information terminal 100 is identified based on a behavioral pattern of the user and thus may be accurately acquired. In addition, since a special device such as an indoor messaging system (IMES) transmitter provided with a function of detecting a floor is not installed, the cost of maintaining an infrastructure may be suppressed.

According to the embodiment, a behavioral pattern of the user is identified based on multiple behaviors of the user. Thus, highly accurate positional information of the mobile information terminal 100 may be acquired, compared with a case where positional information of the mobile information terminal 100 is acquired based on a single behavior.

According to the embodiment, a behavioral pattern that is similar to a behavioral pattern of the user is extracted based on not only the results of comparing the behavioral pattern of the user of the mobile information terminal 100 with a behavioral pattern stored in the learning database 215, but also the results of comparing space-specific information acquired for each behavior of the behavioral pattern with space-specific information stored for each behavior in the learning database 215. Thus, the behavioral pattern that is similar to the behavioral pattern of the user may be accurately acquired from the learning database 215.

In the embodiment, after a behavioral pattern of the user is identified, a current position or target position of the user is identified based on the behavioral pattern. However, the identification of the behavioral pattern of the user corresponds to the acquisition of a relative position of the mobile information terminal 100 to a predetermined position in a building, and the identification of the current position or target position of the user corresponds to the acquisition of positional information (absolute position) of the mobile information terminal 100. As the predetermined position in the building, positional information when the positional information is switched from an outdoor position to an indoor position, positional information when a GPS radio wave is blocked, positional information when the user passes through the security gate, or the like, may be used.

In the embodiment, the function of acquiring positional information of the mobile information terminal 100 is included in the first server 200, while the function of providing a location name or a facility name is included in the second server 300. The functions may be included in a single server or the first server 200, for example.

The control program 2100 according to the embodiment is stored in the auxiliary memory 203. The embodiment, however, is not limited to this. For example, the control program 2100 may be stored in a portable medium such as a CD-ROM or a USB memory.

In the embodiment, positional information associated with a behavioral pattern extracted from the learning database 215 is used as a current position or target position of the mobile information terminal 100. The embodiment, however, is not limited to this. For example, a relative position to a point at which the latest GPS positioning is executed may be calculated based on values detected by the acceleration sensor 106 and gyro sensor 107 and may be used as the current position or target position of the mobile information terminal 100 by adding positional information acquired by the GPS positioning to the relative position. In this case, since the learning database 215 is not used, the technique disclosed herein may be implemented in a simple manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control method executed by an information processing device including a memory configured to store information of a plurality of behavioral patterns associated with positional information, the control method comprising:
receiving, from a mobile device, a plurality of detected values associated with times and each including information of acceleration and an angular velocity;
generating a behavioral pattern corresponding to the mobile device based on the plurality of detected values;
determines a behavioral pattern that is among the plurality of behavioral patterns stored in the memory and is similar to the generated behavioral pattern; and
acquiring positional information associated with the determined behavioral pattern.

2. The control method according to claim 1,
wherein the generating includes generating a behavioral pattern vector having elements that are numerical values assigned to the types of behaviors forming the behavioral pattern and a behavioral characteristic vector having elements that are numerical values each representing a characteristic of the transition between continuous two behaviors among the behaviors.

3. The control method according to claim 2, further comprising
calculating inner products of the generated behavioral pattern vector and a plurality of behavioral pattern vectors stored in the memory, and
wherein the determining includes selecting, from among the plurality of behavioral pattern vectors, a behavioral pattern vector for which the maximum inner product is calculated.

4. The control method according to claim 2,
wherein the behavioral characteristic vector includes, as an element, at least any of the number of steps between continuous two behaviors, a time period between the continuous two behaviors, and a distance between the position of the mobile device when one of the continuous two behaviors occurs and the position of the mobile device when the other of the continuous two behaviors occurs.

5. The control method according to claim 1,
wherein the storing includes storing, in the memory, information of the plurality of behavioral patterns associated with space-specific information representing information identifying access points,
the control method further comprising receiving, from the mobile device, space-specific information corresponding to an access point of the mobile device,
wherein the determining includes comparing, for behaviors forming the behavioral pattern, the received space-specific information with space-specific information associated with the plurality of behavioral patterns stored in the memory.

6. The control method according to claim 5,
wherein the comparing includes determining whether a MAC address received from the mobile device is common to a MAC address acquired from the memory and whether a strength of a signal received from the mobile device is in a range between the minimum value and maximum value acquired from the memory.

7. An information processing device comprising:
a memory configured to store information of a plurality of behavioral patterns associated with positional information;
a processor coupled to the memory and configured to:
receive, from a mobile device, a plurality of detected values associated with times and each including information of acceleration and an angular velocity,
generate a behavioral pattern corresponding to the mobile device based on the plurality of detected values,
determine a behavioral pattern that is among the plurality of behavioral patterns stored in the memory and is similar to the generated behavioral pattern, and
acquire positional information associated with the determined behavioral pattern.

8. The information processing device according to claim 7, wherein the processor is configured to generate a behavioral pattern vector having elements that are numerical values assigned to the types of behaviors forming the behavioral pattern and a behavioral characteristic vector having elements that are numerical values each representing a characteristic of the transition between continuous two behaviors among the behaviors.

9. The information processing device according to claim 8, wherein the processor is configured to:
calculate inner products of the generated behavioral pattern vector and a plurality of behavioral pattern vectors stored in the memory, and
select, from among the plurality of behavioral pattern vectors, a behavioral pattern vector for which the maximum inner product is calculated.

10. The information processing device according to claim 8,
wherein the behavioral characteristic vector includes, as an element, at least any of the number of steps between continuous two behaviors, a time period between the continuous two behaviors, and a distance between the position of the mobile device when one of the continuous two behaviors occurs and the position of the mobile device when the other of the continuous two behaviors occurs.

11. A non-transitory computer-readable storage medium storing a program that causes a computer to execute a process, the computer including a memory configured to store information of a plurality of behavioral patterns associated with positional information, the process comprising:
receiving, from a mobile device, a plurality of detected values associated with times and each including information of acceleration and an angular velocity;
generating a behavioral pattern corresponding to the mobile device based on the plurality of detected values;
determines a behavioral pattern that is among the plurality of behavioral patterns stored in the memory and is similar to the generated behavioral pattern; and
acquiring positional information associated with the determined behavioral pattern.
